(19) United States
(12) Patent Application Publication
(10) Pub. No.: US 2016/0346742 A1
(43) Pub. Date: Dec. 1, 2016

(54) TWO PIECE DISSOLUTION INSTRUMENT AGITATOR SHAFT ASSEMBLY

(71) Applicant: Quality Lab Accessories, LLC, Telford, PA (US)

(72) Inventors: Gregory Z. Hitchens, Telford, PA (US); Russell Brandriff, Warrington, PA (US)

(73) Assignee: Quality Lab Accessories, LLC, Telford, PA (US)

(21) Appl. No.: 15/168,013

(22) Filed: May 28, 2016

Related U.S. Application Data
(60) Provisional application No. 62/168,779, filed on May 30, 2015.

(51) Int. Cl. B01F 1/00; B01F 7/16

(52) U.S. Cl. CPC B01F 1/0011; B01F 7/1605; B01F 2215/0032

(57) ABSTRACT

A two-piece dissolution instrument agitator shaft assembly of a dissolution instrument, comprising a tapered connection with no diametrical clearance between first and second mating sections wherein an inner diameter of the first mating section is equal to or less than an outer diameter of the second mating section.

### CROSS-REFERENCE TO RELATED APPLICATIONS

This Application claims the benefit of priority of co-pending U.S. Utility Provisional Patent Application 62/168,779, filed 30 MAY 2015, the entire disclosure of which is expressly incorporated by reference in its entirety herein.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

Field of the Invention

One or more embodiments of the present invention relate to shaft assemblies used in dissolution instruments and in particular, to two-piece dissolution instrument agitator shaft assemblies.

Description of Related Art

Drugs are commonly manufactured in the form of pills, which are disseminated into the body over a period as the pill dissolves. Manufacturers of pills are required by law to determine the precise dissolving characteristics of a pill before it is placed on the market.

In the pharmaceutical industry, the stirring or agitation of sample drugs or other substances in test vessels is an important step in mimicking the dissolution rate or dissolution characteristics of a drug within the stomach. Examples of such test procedures include those performed for the purpose of testing and analyzing the rate at which doses of a drug is released from pharmaceutical products, such as tablets or capsules, under controlled conditions.

The procedural steps, test duration, dissolution medium, and apparatus employed in dissolution tests typically must comply with established, well-recognized guidelines, such as those promulgated by United States Pharmacopeia (USP) in order for the test to be accepted as valid for the specific substance tested. The apparatus utilized for carrying out dissolution testing typically includes a vessel plate having an array of apertures into which test vessels are mounted.

Each test vessel includes a liquid called media, which is a dissolution bath that essentially duplicates the liquid solution that is contained within the stomach, with a precise quantity of the solution placed within the test vessel. The pill or capsule to be tested is then inserted within the test vessel with a dissolution instrument agitator shaft assembly (e.g., a mixing paddle) inserted therein the test vessel to mix the solution at a precise rate, which duplicates the natural turbulence (churning) that is created within the stomach. Aliquots are then removed from the solution at precise time intervals, which are then analyzed to determine the amount of drug that has been dissolved within the solution in relation to the time that the pill or capsule has been in the solution.

Accordingly, dissolution instruments are highly precision multiple spindle instruments that are used to test the dissolution rate of pharmaceutical drugs. As best illustrated in the related art FIGS. 1A to 1H, dissolution instruments commonly use two-piece shaft assemblies 102 (FIGS. 1A and 1B) that are rotated by the dissolution instruments.

An important USP specification related to two-piece shaft assemblies 102 used by dissolution instruments is wobbling, which should not exceed a maximum of 1.0 mm. It is commonly known that excessive wobble (unsteady movement from side to side) of rotating shaft assemblies 102 contributes to dissolution test error, which is the result of an unaccounted change in hydrodynamics within the dissolution vessel when a paddle or basket portion (detailed below) of a shaft assembly exhibits excessive wobble due to the wobbling of the rotating shaft assembly.

Accordingly, in light of the current state of the art and the drawbacks to current shaft assemblies mentioned above, a need exists for a dissolution instrument shaft assembly with substantially reduced wobbling.

### BRIEF SUMMARY OF THE INVENTION

A non-limiting, exemplary aspect of an embodiment of the present invention provides a two-piece dissolution instrument agitator shaft assembly of a dissolution instrument, comprising:

tapered connection with no diametrical clearance between first and second mating sections;

wherein an inner diameter of the first mating section is equal to or less than an outer diameter of the second mating section.

Another non-limiting, exemplary aspect of an embodiment of the present invention provides a a two-piece dissolution instrument agitator shaft assembly of a dissolution instrument, comprising:

an upper shaft that is associated with a drive spindle of the dissolution instrument;

a lower shaft that is immersed into a vessel filled with solution, with upper and lower shafts detachably coupled together by a complementary female and male connecting structures of respective upper and lower shafts to form the two-piece dissolution instrument agitator shaft assembly;

wherein an inner diameter of the female connecting structure is equal to or less than an outer diameter of the male connecting structure.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1H are exemplary illustrations of various views of a conventional two-piece, paddle and basket shafts currently used with dissolution instruments; and

FIGS. 2A to 2F are non-limiting, exemplary illustrations of various views of two-piece dissolution instrument agitator shaft assembly in accordance with one or more embodiments of the present invention with substantially reduced wobbling.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

Throughout the disclosure, references to a paddle shaft assembly or basket shaft assembly are meant as illustrative, convenience of example, and for discussion purposes only. That is, the present invention should not be limited to use of a “paddle” or “basket” shafts or assemblies thereof but may also be used (without much modifications, if any) for other types of dissolution instruments shaft assemblies that may or may not be used for agitation or mixing in the pharmaceutical industry.

In the description given below and or the corresponding set of drawing figures, when it is necessary to distinguish the various members, elements, sections/portions, components, parts, or any other aspects (functional or otherwise) or features or concepts or operations of a device(s) or method(s) from each other, the description and or the corresponding drawing figures may follow reference numbers with a small alphabet character such as (for example) “paddle shaft assembly 102a, basket shaft assembly 102b, and etc.” If the description is common to all of the various members, elements, sections/portions, components, parts, or any other aspects (functional or otherwise) or features or concepts or operations of a device(s) or method(s) such as (for example) to all shaft assemblies, then they may simply be referred to with reference number only and with no alphabet character such as (for example) “shaft assembly 102.”

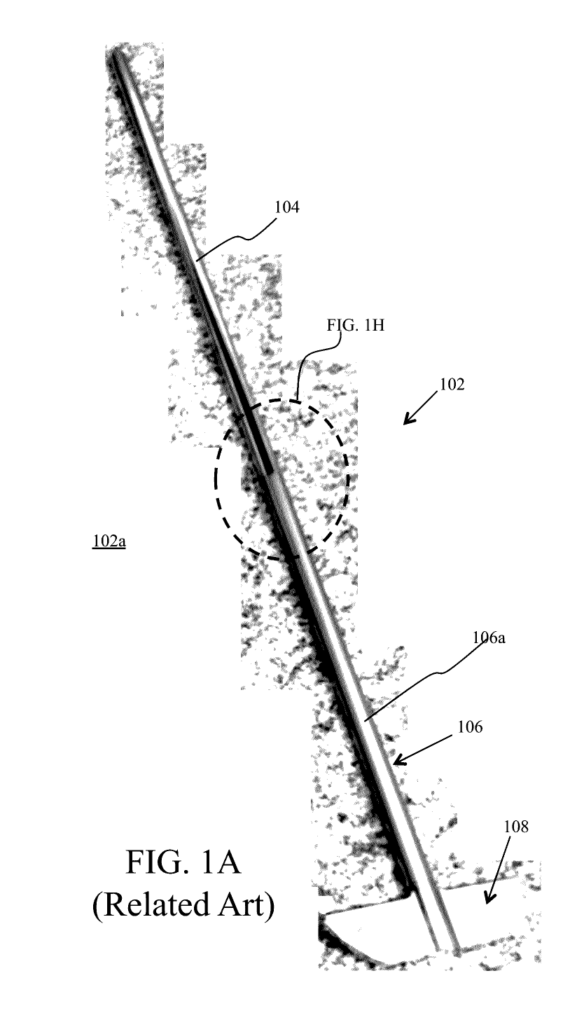

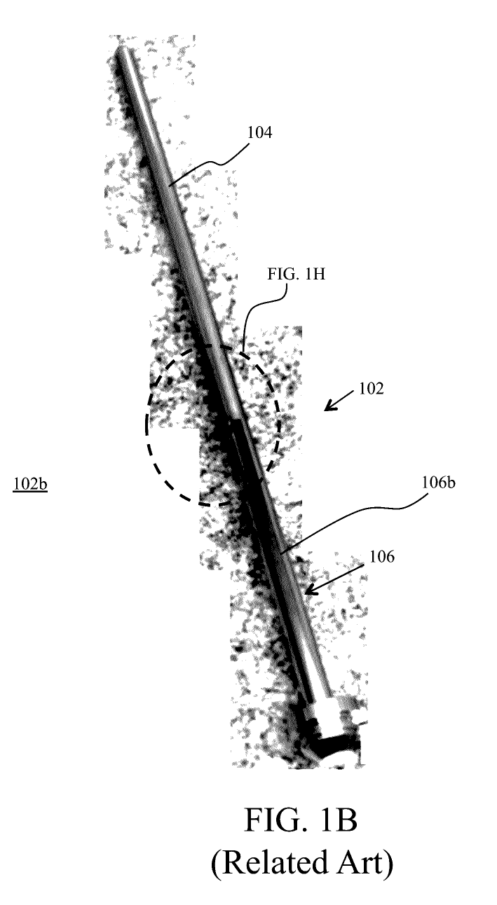

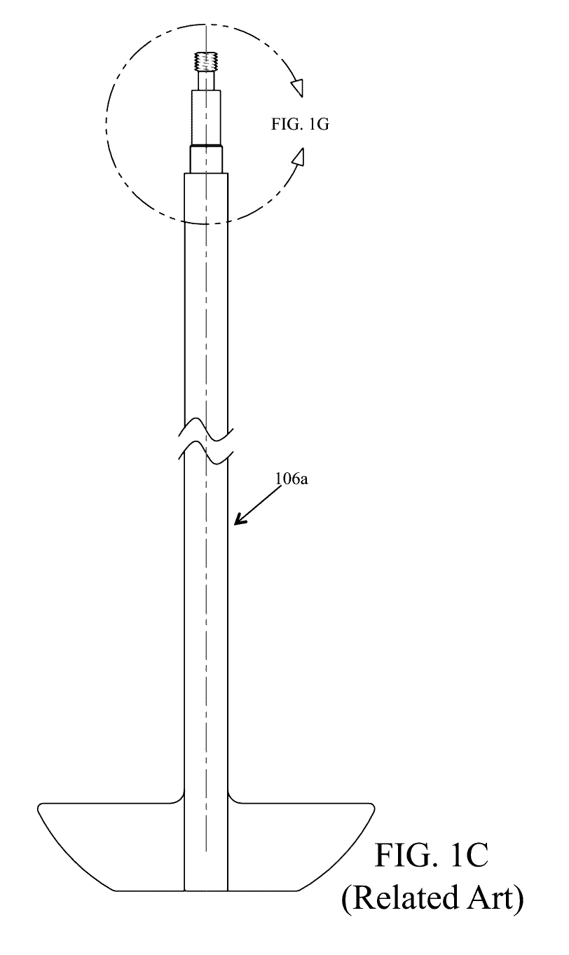

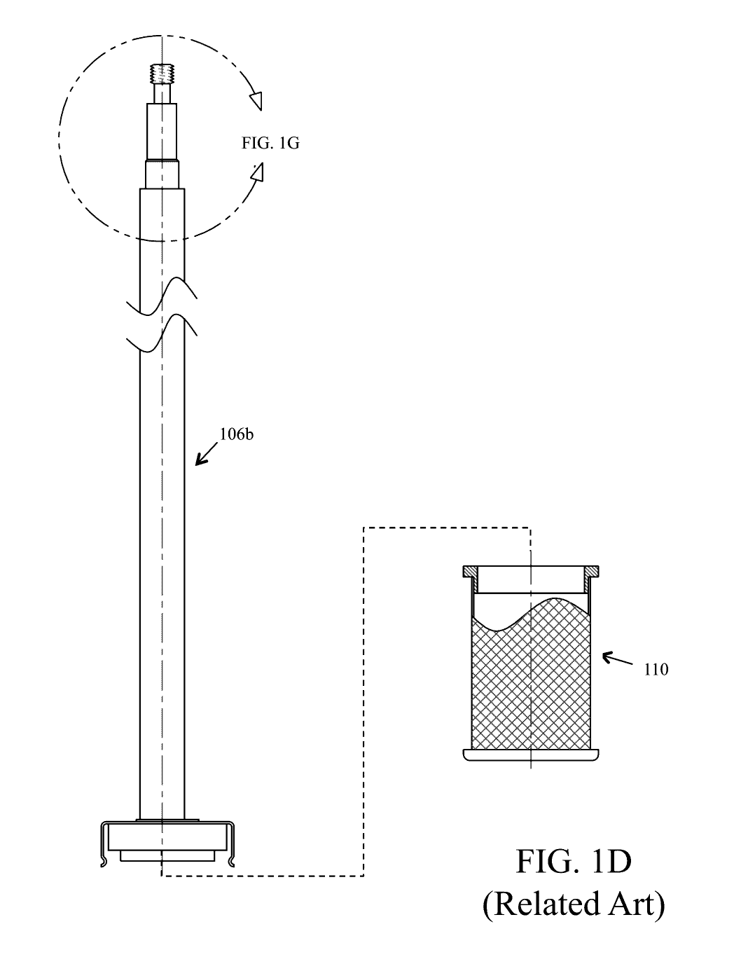

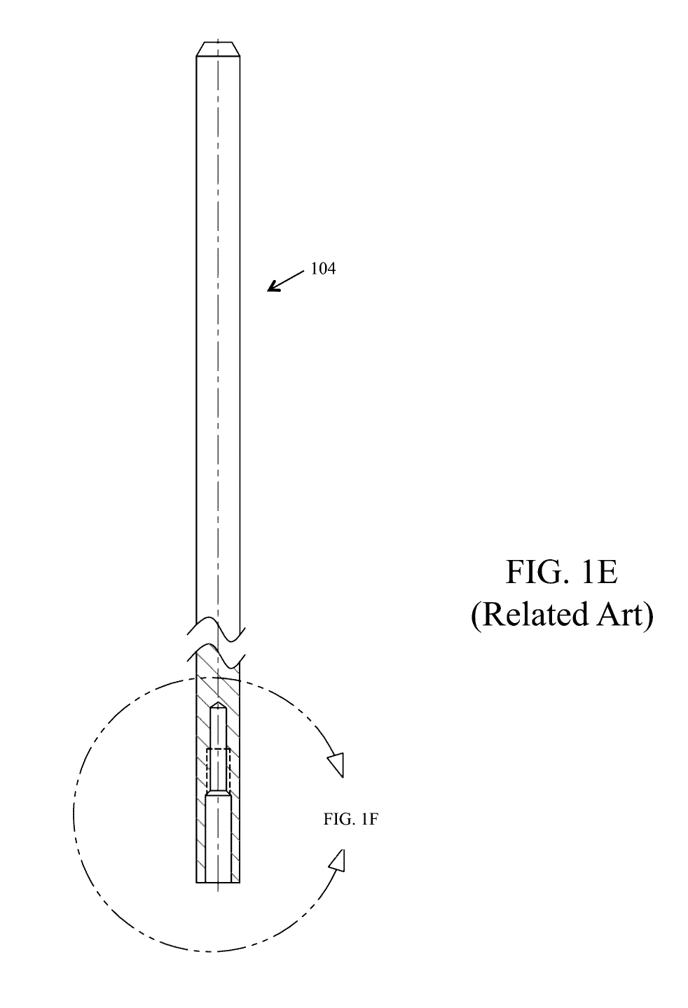

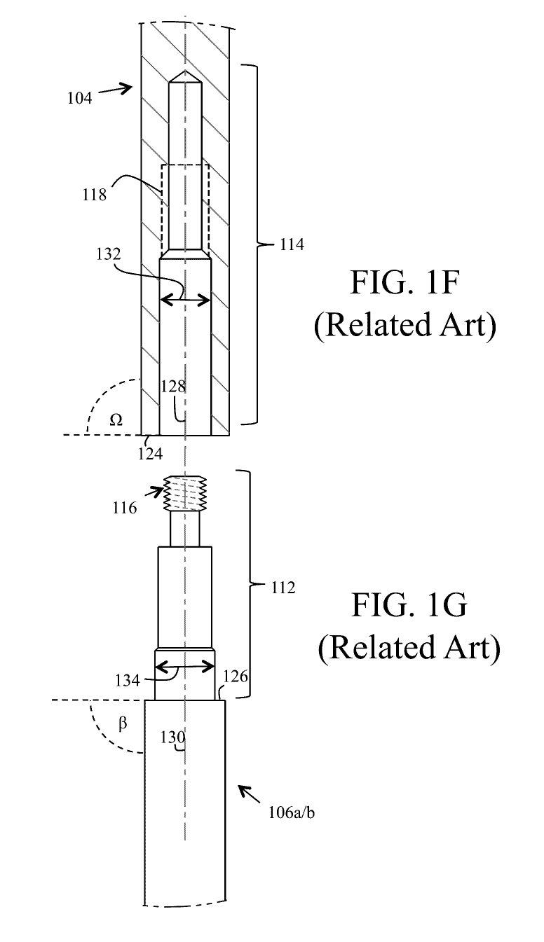

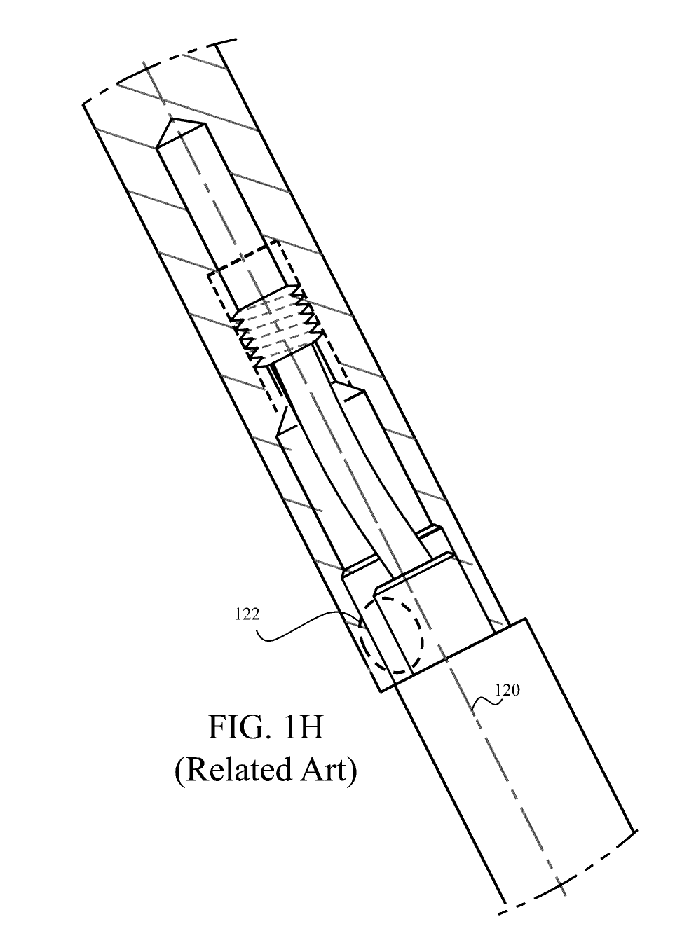

FIGS. 1A to 1H are exemplary illustrations of a conventional two-piece, paddle and basket shafts currently used with dissolution instruments. As illustrated in FIGS. 1A to 1H, a two-piece shaft assembly 102 is comprised of an upper shaft 104 that is associated with a drive spindle of the dissolution instrument, and a lower shaft 106 that is immersed into the solution, with upper and lower shafts 104 and 106 connected together (FIGS. 1F, 1G, and 1H) to form the shaft assembly 102.

In general, if lower shaft 106 has a paddle 108 (FIGS. 1A and 1C), shaft assembly 102 is referred to as a paddle shaft assembly 102a whereas if lower shaft 106 has a basket 110 (FIGS. 1B and 1D), shaft assembly 102 is referred to as a basket shaft assembly 102b. Accordingly, lower shaft 106 may be a paddle shaft 106a (FIG. 1C) or a basket shaft 106b (FIG. 1D) that assemble with upper shaft 104 (FIG. 1E) to form either a paddle shaft assembly 102a (FIG. 1A) or a basket shaft assembly 102b (FIG. 1B), with both using identical upper shaft 104. In general, the basket 110 is detachably coupled with the basket shaft 106b.

As best illustrated in FIGS. 1F, 1G, and 1H, lower shaft 106 includes a male coupler 112 that connects with a female coupler 114 of upper shaft 104. In general, male coupler 112 of lower shaft 106 includes a threaded end 116 that threads within a threaded wall 118 of the female coupler 114 of upper shaft 104 (best illustrated in FIG. 1H).

In general, excessive wobble is generally a function of straightness of shaft assembly 102 along its longitudinal axis 120. In particular, an important aspect of the present invention is the discovery that straightness of conventional two-piece shaft assembly 102 along its longitudinal axis 120 is impacted by geometric tolerances of the mating parts. In other words, geometric tolerances and variations cause critical diametrical clearance 122 (FIG. 1H) to be potentially taken up on one side of the mating sections 112 and 114 of two-piece shaft assembly 102, resulting in eccentricity of assembled shaft and potential wobble during operation.

It should be noted that it is not just geometric tolerances (that allows for some error), but actual intentional design of mating sections 112 and 114 that allows for undesirable diametric clearance 122. In particular, inner diameter 132 of mating section 114 is designed to be larger than an outer diameter 134 of mating section 112 to enable upper shaft 104 to receive and mate with lower shaft 106. Accordingly, diametric clearance is in fact the very slight or small delta (or difference) between inner and outer diameters 132 and 134. Therefore, mating sections 114 and 116 have two contact points or surfaces—threading between outer threaded male 116 and inner threaded female 118 threading points, and periphery or edge mating surfaces 124 and 126. Although mating sections 114 and 116 have two contact points or surfaces, they only have the threading that connects them together and hence, wobbling may also occur if for any reason that threaded connection is loosened.

Another important aspect of the present invention is the discovery that perpendicularity of mating surfaces 124 and 126 (FIGS. 1F and 1G) in relation to their respective longitudinal axis 128 and 130 is also impacted by geometric tolerances of mating parts 112 and 114. If mating surfaces 124 and 126 are at some respective angles S2 and B in relation to their respective longitudinal axis 128 and 130 rather than being perpendicular, the overall straightness of the assembled two-piece shaft assembly 102 along the overall longitudinal axis 120 would also be affected, resulting in wobbling of two-piece shaft assembly 102 during operation.

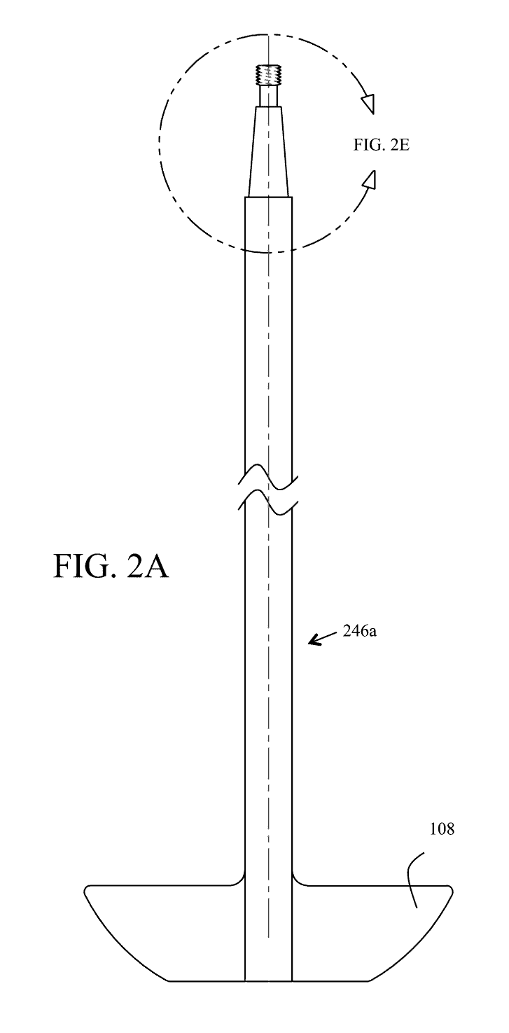

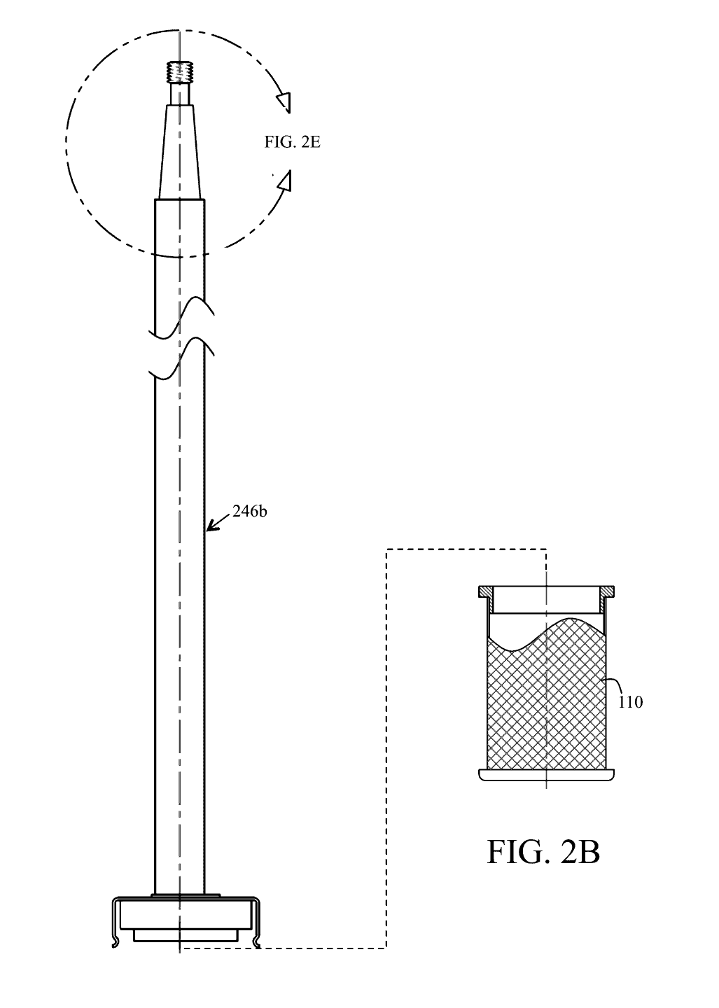

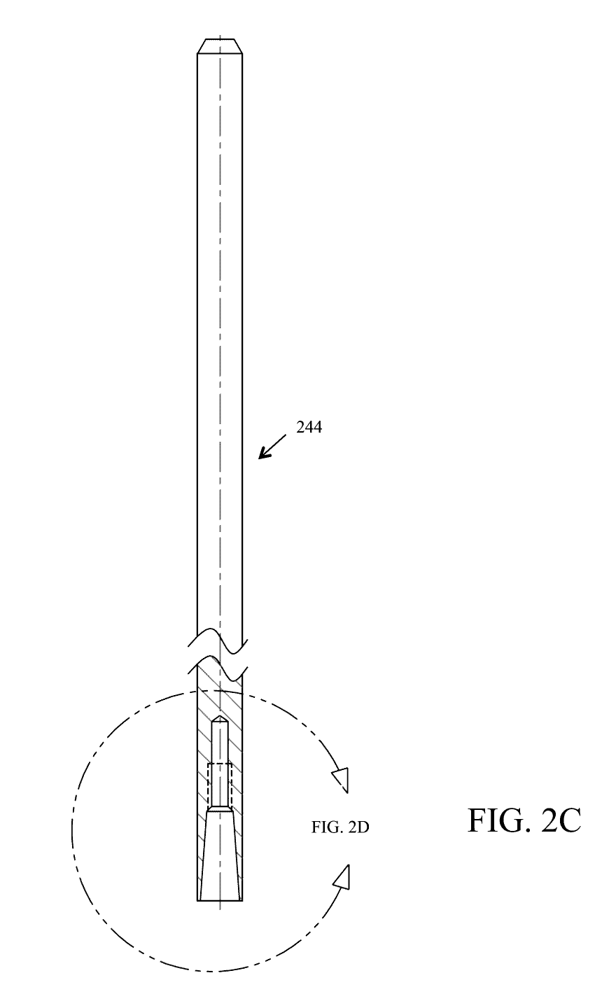

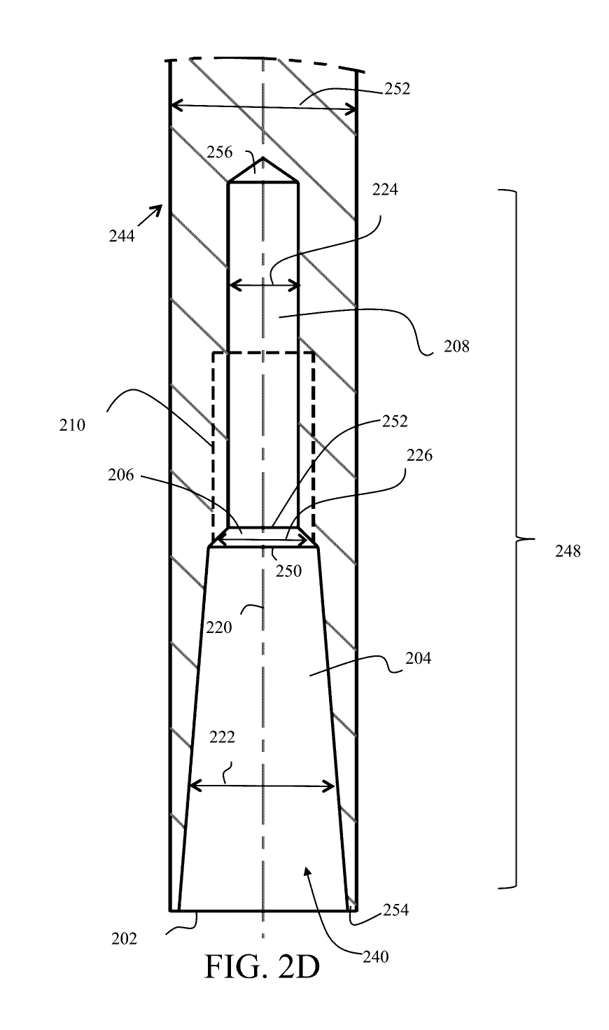

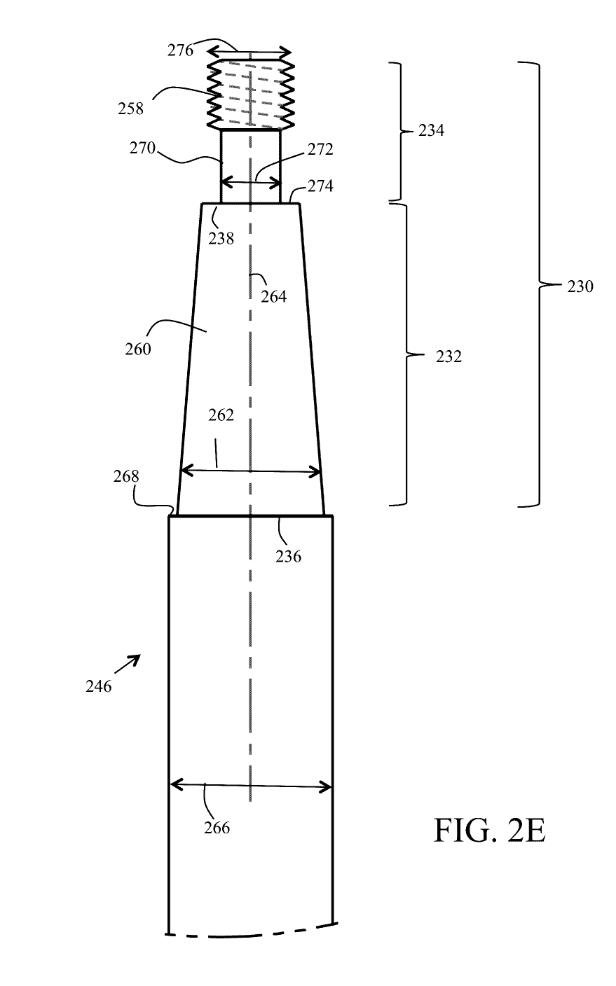

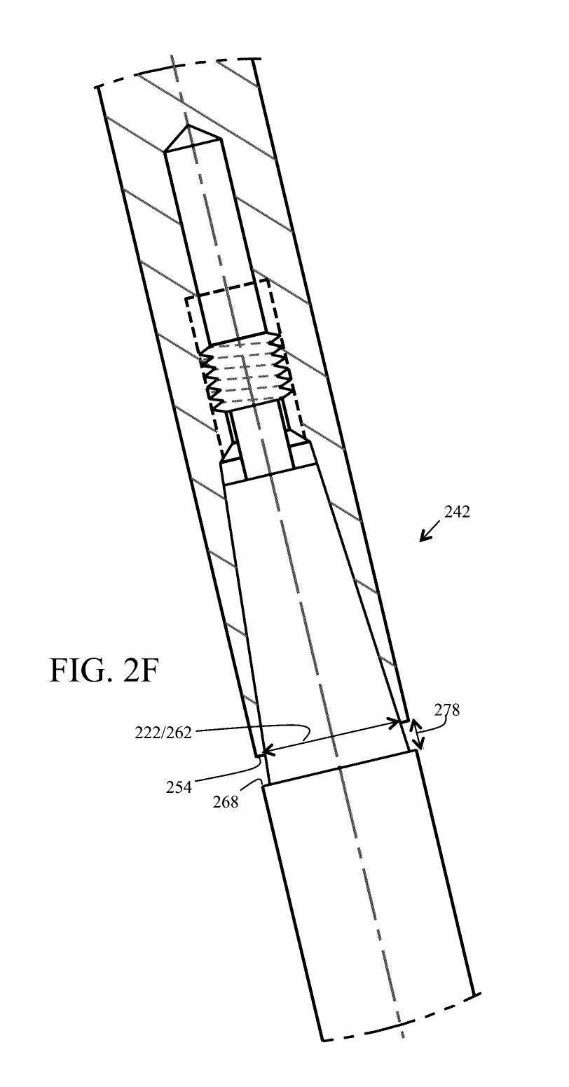

Accordingly, one or more embodiments of the present invention provide a dissolution instrument shaft assembly that obviates the problems with the conventional shafts, resulting in a substantially reduced wobbling. FIGS. 2A to 2F are non-limiting, exemplary illustrations of two-piece dissolution instrument agitator shaft assembly in accordance with one or more embodiments of the present invention with substantially reduced wobbling.

As detailed below, one or more embodiments of the present invention eliminate design requirement for diametric clearance 122 between mating structures and further, eliminate the need for contact between mating surfaces 124 and 126, which simply eliminate potential contributions to wobbling from these sources. Further, one or more embodiments of the present invention provide frictional as well as threaded connectivity, which further reduce the potential of dissolution instrument shaft assembly being loosened at the treading.

As illustrated in FIGS. 2A to 2F, one or more embodiments of the present invention provide a two-piece dissolution instrument agitator shaft assembly 242 of dissolution instrument that is composed of an upper shaft 244 that is associated with a drive spindle of the dissolution instrument and a lower shaft 246 that is immersed into a solution, with upper and lower shafts 244 and 246 detachably coupled together by a complementary female and male connecting structures 248 and 230 of respective upper and lower shafts 244 and 246 to form the two-piece dissolution instrument shaft assembly 242.

In general, if lower shaft 246 has a paddle 108, two-piece dissolution instrument agitator shaft assembly 242 is referred to as a dissolution instrument paddle shaft assembly 242a whereas if lower shaft 246 has a basket 110, two-piece dissolution instrument agitator shaft assembly 242 is referred to as a dissolution instrument basket shaft assembly 242b. Accordingly, lower shaft 246 may be a paddle shaft 246a or a basket shaft 246b that assemble with upper shaft 244 to form either a dissolution instrument paddle agitator shaft assembly 242a or a dissolution instrument agitator basket shaft assembly 242b, with both using identical upper shaft 244. In general, basket 110 is detachably coupled with the basket shaft 246b.

As best illustrated in FIGS. 2D to 2F, lower shaft 246 includes a male connecting structure 230 that connects with a female connecting structure 248 of upper shaft 244 to form two-piece dissolution instrument agitator shaft assembly 242. As best illustrated in FIG. 2D, female connecting structure 248 is comprised of an opening 202 that leads into a cavity 240 with a central longitudinal axis 220. Cavity 240 is comprised of a primary frustum of an elongated right circular cone (first chamber 204) that has a diameter 222 that decreases along a central longitudinal axis of first chamber 204 from opening 202 to distal end 250, with the opening diameter having a span that is longer than distal end diameter. Additionally, opening diameter has a shorter span than upper shaft diameter 252, with difference between opening diameter and that of upper shaft diameter 252 defining a lower periphery edge 254 of upper shaft 244.

Cavity 240 further includes a secondary frustum of a short right circular cone (second chamber 206) that has a diameter 250 that decreases along a central longitudinal axis of second (or intermediate) chamber 206 from a first distal end (which is the same as distal end 250) to distal end 252, with the first distal end diameter having a span that is longer than second distal end diameter. It should be noted that intermediate chamber 206 is a result of manufacturing process using tooling to bore and create the next chamber (blind-hole chamber 208 detailed below) in relation to first chamber 204.

As further illustrated, cavity 240 further includes a cylindrically configured blind-hole (third chamber 208) that has internal threading 210, with chamber 208 having a constant diameter 224. The very tip 256 of chamber 208 having a cone structure is the result of tooling that bored blind-hole chamber 208.

Accordingly, overall, cavity 240 includes a diameter that decreases along central longitudinal axis 220 of cavity 240 from opening 202 to blind-hole chamber 208, with diameter 222 of chamber 204 at opening 202 larger than a next, subsequent diameter 226 of chamber 206, with a final diameter 224 of blind-hole chamber 208 of cavity 240 being generally constant and smallest.

First chamber 204, the intermediate chamber 206, and blind-hole chamber 208 have a common axial center (which is the same as central longitudinal axis 220), with first chamber 204 associated with blind-hole chamber 208 by intermediate chamber 206 in a cascading series of sequentially decreasing dimension. The first chamber 204, the intermediate chamber 206, and blind-hole chamber 208 are therefore concentric chambers.

As best illustrated in FIG. 2E, male connecting structure 230 is comprised of a first section 232 and a second section 234. First section 232 is comprised of a frustum of an elongated right circular cone 260 that has a diameter 262 that decreases along a central longitudinal axis 264 of first section 232 from a first distal end 236 to a second distal end 238, with a first distal end diameter having a span that is longer than a second distal end diameter at the second distal end 238. First distal end diameter has a shorter span than lower shaft diameter 266, with difference between first distal end diameter of first section 232 and that of lower shaft diameter 266 defining a periphery upper edge 268 of lower shaft 246.

As further illustrated, male connecting structure 230 also includes second section 234, which is composed of a first cylindrical portion 270 that forms a relief (or recess), and a second cylindrical portion 258 with outer threading. First cylindrical portion 270 is positioned between second distal end 238 of first section 232, forming a bottom or base of second cylindrical portion 258. First cylindrical portion has a first cylindrical diameter 272 that is shorter than a diameter of the second distal end 238, forming a periphery upper edge 274 of first section 232, with a second cylindrical diameter 276 being longer than first cylindrical diameter 272.

As best illustrated in FIG. 2F, outer threading 258 of male connecting structure 230 of lower shaft 246 threads within inner threading 210 of female connecting structure 248 of upper shaft 244. Further, outer diameter 262 of first section 232 of male connecting structure 230 of lower shaft 246 has a generally longer span near the first distal end 236 compared to inner diameter 222 of first chamber 204 of female connecting structure 248 of upper shaft 244 at opening 202. However, there is a point at which inner diameter 222 of first chamber 208 at opening 202 is equal to outer diameter 262 of first section 232. Accordingly, as male connecting structure 230 of lower shaft 246 is inserted within cavity 240 of upper shaft 244 and threaded, first section 232 continues to move and be inserted within chamber 208 until the point at which outer diameter 262 equals inner diameter 222 at opening 202. Thereafter, lower shaft 246 can no longer be further inserted (or be pulled in by threading 258/210) into upper shaft 244 (best illustrated in FIG. 2F). This eliminates the undesired diametric clearance because inner surface wall of first chamber 208 fully contacts outer surface wall of first section 232 at least at point where the inner and outer diameters 222 and 262 are equal.

As further illustrated, locations where the size of outer diameter 262 is equal to the size of inner diameter 222 are near respective first distal ends 236 and at opening 202 so that periphery upper edge 268 of lower shaft 246 never come into contact with lower periphery edge 254 of upper shaft 244. In other words, outer diameter 262 of first section 232 is sized such that it equals the inner diameter 222 at opening 202 where lower periphery edge 254 and periphery upper edge 268 are separated by distance 278 and hence, never contact one another when two-piece dissolution instrument agitator shaft assembly 242 is fully assembled. Accordingly, one or more embodiments of the present invention eliminate design requirement for diametric clearance between mating structures and further, eliminate the need for contact between mating surfaces, eliminating potential contributions to wobbling from these sources. Further, due to equality between inner and outer diameters as described, a frictional hold is generated at the contacting surfaces, which reduce potential of loosening of lower and upper shaft connections.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of in the claims herein is not intended to invoke the provisions of 35 U.S.C. 112, Paragraph 6.

What is claimed is:

1. A two-piece dissolution instrument agitator shaft assembly of a dissolution instrument, comprising:
tapered connection with no diametrical clearance between first and second mating sections;
wherein an inner diameter of the first mating section is equal to or less than an outer diameter of the second mating section.

2. A two-piece dissolution instrument agitator shaft assembly of a dissolution instrument, comprising:
an upper shaft that is associated with a drive spindle of the dissolution instrument;
a lower shaft that is immersed into a vessel filled with solution, with upper and lower shafts detachably coupled together by a complementary female and male connecting structures of respective upper and lower shafts to form the two-piece dissolution instrument agitator shaft assembly;
wherein an inner diameter of the female connecting structure is equal to or less than an outer diameter of the male connecting structure.

3. The two-piece dissolution instrument agitator shaft assembly of a dissolution instrument as set forth in claim 2, wherein:
the female connecting structure is comprised of:
an opening that leads into a cavity with a central longitudinal axis.

4. The two-piece dissolution instrument agitator shaft assembly of a dissolution instrument as set forth in claim 3, wherein:
the cavity is comprised of:
a frustum of an elongated right circular cone that has a diameter that decreases along a central longitudinal axis of first section from a first distal end to a second distal end, with a first distal end diameter having a span that is longer than a second distal diameter at the second distal end.

5. The two-piece dissolution instrument agitator shaft assembly of a dissolution instrument as set forth in claim 3, wherein:
the first distal end diameter has a shorter span than an upper shaft diameter, with difference between first distal end diameter and that of upper shaft diameter defining a lower periphery edge of upper shaft.

6. The two-piece dissolution instrument agitator shaft assembly of a dissolution instrument as set forth in claim 4, further comprising:
a second cylindrical portion that forms a blind-hole that has internal threading;

7. The two-piece dissolution instrument agitator shaft assembly of a dissolution instrument as set forth in claim 3, wherein:
the cavity is comprised of:
a diameter that decreases along the central longitudinal axis of the cavity from the opening of the cavity to a blind-hole of the cavity, with a first diameter at opening larger than a next, subsequent diameter, with a second diameter of blind-hole being smallest.

8. The two-piece dissolution instrument agitator shaft assembly of a dissolution instrument as set forth in claim 7, wherein:
the first diameter is smaller than diameter of upper shaft, forming a lower peripher edge of upper shaft.

9. The two-piece dissolution instrument agitator shaft assembly of a dissolution instrument as set forth in claim 3, wherein:
the cavity is comprised of:
a series of plurality of chambers, with a first chamber at opening having a first dimension and a final chamber defined by blind-hole having a second dimension, with the first dimension larger than the second dimension.

10. The two-piece dissolution instrument agitator shaft assembly of a dissolution instrument as set forth in claim 9, wherein:
a first chamber of the series of plurality of chambers is integral with a next, subsequent chamber by an intermediate chamber, with the intermediate chamber comprising:
a first end that is integral with the first chamber and a second end that is integral with the next, subsequent chamber, with the intermediate chamber having a gradient that decreases from the first end to the second end.

11. The two-piece dissolution instrument agitator shaft assembly of a dissolution instrument as set forth in claim 10, wherein:
the first chamber, the intermediate chamber, and blind-hole chamber have a common axial center, with the first chamber associated with blind-hole chamber by intermediate chamber in a cascading series of sequentially decreasing dimension.

12. The two-piece dissolution instrument agitator shaft assembly of a dissolution instrument as set forth in claim 11, wherein:
the first chamber, the intermediate chamber, and blind-hole chamber are concentric chambers.

13. The two-piece dissolution instrument agitator shaft assembly of a dissolution instrument as set forth in claim 11, wherein:
first chambers and blind-hole chamber are comprised of integral concentric configurations integrally associated with a concentric intermediate chamber, with first and intermediate chambers comprised of a substantially configured frustum, with chambers associated sequentially in a cascading decreasing dimension.

14. The two-piece dissolution instrument agitator shaft assembly of a dissolution instrument as set forth in claim 3, wherein:
the cavity is a single piece integral unit comprised of:
a first chamber that is a first frustum of a first right circular cone;
a second chamber that is a second frustum of a second right circular cone; and
a third blind-hole chamber that is cylindrical;
with the first, second, and third chambers being concentric, having decreasing radius along a common central longitudinal axis, and forming a single piece, integral cavity.

15. The two-piece dissolution instrument agitator shaft assembly of a dissolution instrument as set forth in claim 2, wherein:
the male connecting structure is comprised of:
first section and a second section;
the first section is comprised of:
frustum of an elongated right circular cone that has a diameter that decreases along a central longitudinal axis of first section from a first distal end to a second distal end, with a first distal end diameter having a span that is longer than a second distal diameter at the second distal end.

16. The two-piece dissolution instrument agitator shaft assembly of a dissolution instrument as set forth in claim 15, wherein:
the first distal end diameter has a shorter span than lower shaft diameter, with difference between first distal end diameter of first section and that of lower shaft diameter defining a periphery edge of lower shaft.

17. The two-piece dissolution instrument agitator shaft assembly of a dissolution instrument as set forth in claim 15, wherein:
the second section is comprised of:
a first cylindrical portion that forms a relief in a form of recess; and
a second cylindrical portion that is threaded;
first cylindrical portion is positioned between the second distal end of the first section, forming a base of the second cylindrical portion;
first cylindrical portion has a first cylindrical diameter that is shorter than second distal end diameter, forming a periphery upper edge of the first section, with a second cylindrical diameter being longer than first cylindrical diameter.

18. The two-piece dissolution instrument agitator shaft assembly of dissolution instrument as set forth in claim 2, wherein:
the two-piece dissolution instrument agitator shaft assembly is a two-piece dissolution instrument agitator paddle shaft assembly, with a lower shaft that is a paddle shaft.

19. The two-piece dissolution instrument agitator shaft assembly of dissolution instrument as set forth in claim 2, wherein:
the two-piece dissolution instrument agitator basket shaft assembly is a basket shaft assembly, with a lower shaft that accommodates a basket.

20. The two-piece dissolution instrument agitator shaft assembly of dissolution instrument as set forth in claim 19, wherein:
the basket 110 is detachably coupled to the basket shaft of the two-piece dissolution instrument agitator basket shaft assembly.
